(19) United States
(12) Patent Application Publication
(10) Pub. No.: US 2018/0090807 A1
(43) Pub. Date: Mar. 29, 2018

(54) HOLLOW CONDUCTOR SYSTEM AND METHOD FOR ASSEMBLING A HOLLOW CONDUCTOR SYSTEM

(71) Applicants: Andreas Raith, Prackenbach (DE); Markus Voegerl, Traitsching (DE)

(72) Inventors: Andreas Raith, Prackenbach (DE); Markus Voegerl, Traitsching (DE)

(73) Assignee: Rohde & Schwarz GmbH & Co. KG, Munich (DE)

(21) Appl. No.: 15/719,034

(22) Filed: Sep. 28, 2017

(30) Foreign Application Priority Data
Sep. 29, 2016 (EP) 16191571.5

(51) Int. Cl. H01P 1/04; H01P 3/12; H01P 1/02; H01R 4/60; H01R 43/02

(52) U.S. Cl. CPC H01P 3/12; H01R 43/02; H01R 4/60; H01P 1/02

(57) ABSTRACT

A hollow conductor system is described which comprises at least two hollow conductor bundles and at least two connecting members. Each hollow conductor bundle comprises at least two hollow conductors separated by each other via a common intermediate wall. Each connecting member connects one hollow conductor of one hollow conductor bundle with a corresponding hollow conductor of the other hollow conductor bundle such that a void is provided between the connecting member and the adjacent connecting member and/or an adjacent hollow conductor. Further, a method for assembling a hollow conductor system is described.

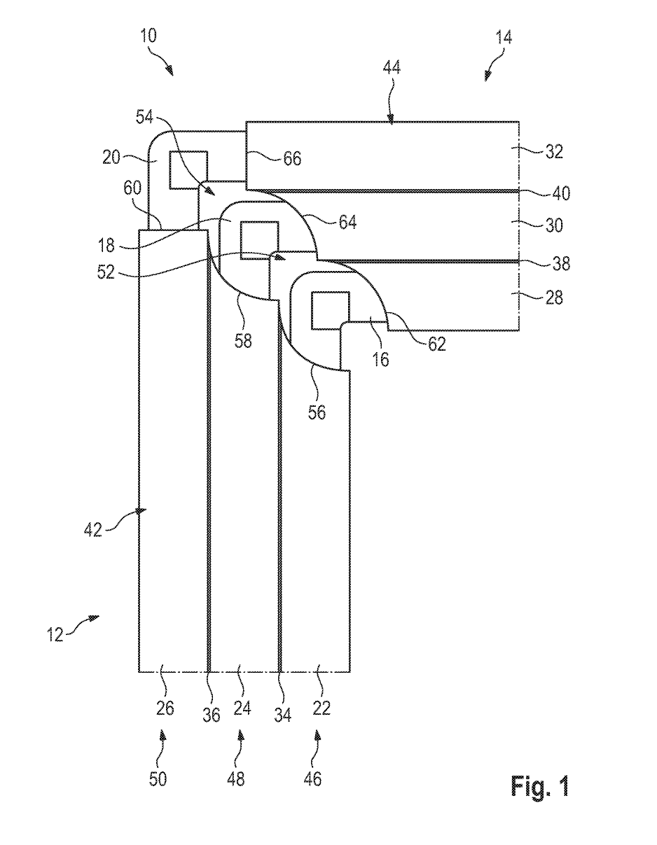

### FIELD OF THE DISCLOSURE

The disclosure relates to a hollow conductor system and a method for assembling a hollow conductor system.

### BACKGROUND

In general, a hollow conductor connecting member is used to connect two separately formed hollow conductors. Depending on its shape, the hollow conductor connecting member may have different characteristics. For instance, the hollow conductor connecting member can be an E-plane bend or an H-plane bend.

Usually, a hollow conductor connecting member is formed as a muffle wherein the hollow conductor connecting member has connecting portions which surround the hollow conductors wherein the hollow conductors may be formed rectangular. The hollow conductors and the hollow conductor connecting member placed between the hollow conductors establish a hollow conductor system which ensures that the electromagnetic waves propagating through the hollow conductors and the hollow conductor connecting member are transferred to a desired location.

Generally, hollow conductors are also called wave guides, hollow wave guides, rectangular wave guides, HF-wave guides, hollow-metallic wave guides, etc.

Such a hollow conductor system may be used in applications which typically have restricted available space for the hollow conductor system. In addition, a lightweight, cost-optimized and mechanically stable hollow conductor system is required which can be assembled easily.

Furthermore, the electrical losses during the transmission of electromagnetic waves have to be minimized by the hollow conductor system. Thus, an efficient hollow conductor is also required.

### SUMMARY

Embodiments of the disclosure provide a hollow conductor system comprising at least two hollow conductor bundles and at least two connecting members wherein each hollow conductor bundle comprises at least two hollow conductors separated by each other via a common intermediate wall wherein each connecting member connects one hollow conductor of one hollow conductor bundle with a corresponding hollow conductor of the other hollow conductor bundle such that a void is provided between the connecting member and the adjacent connecting member and/or an adjacent hollow conductor.

Embodiments of the disclosure are based on the finding that a lightweight hollow conductor system can be provided as several hollow conductors are combined in a hollow conductor bundle wherein the different hollow conductors of each hollow conductor bundle are interconnected by the connecting members such that several hollow conductor lines are established. The weight of the hollow conductor system is further reduced by the void provided between one connecting member and the adjacent connecting member and/or an adjacent hollow conductor. Furthermore, the void ensures better electrical properties as the electrical losses are minimized due to the different materials adjoining each other, in particular air as well as the material of the hollow conductor bundles. Furthermore, a compact design is provided as the hollow conductors of each hollow conductor bundle are directly connected with each other via the intermediate walls. This also improves the mechanical stability of the whole hollow conductor system.

Each hollow conductor is composed of walls encompassing a space that is used for conducting electromagnetic waves. The hollow conductor bundle is composed of at least two hollow conductors orientated substantially parallel to each other wherein these hollow conductors share a common intermediate wall. Accordingly, this common intermediate wall encompasses the spaces partly simultaneously.

The common intermediate wall extends substantially in the propagation direction of the electromagnetic waves propagating through the spaces defined by the hollow conductors. Accordingly, the hollow conductors of the same hollow conductor bundle separated from each other by the common intermediate wall are arranged adjacent to each other in a gapless manner.

Accordingly, the common intermediate wall confines the space of both hollow conductors of the same hollow conductor bundle partly in order to ensure that the electromagnetic waves cannot exit the hollow conductors inadvertently due to the common intermediate wall.

Each connecting member connects two respective hollow conductors of the hollow conductor bundles to ensure a hollow conductor line. Thus, the hollow conductor line is defined by a first hollow conductor of the first hollow conductor bundle, the connecting member and the first hollow conductor of the second hollow conductor bundle connected to the first hollow conductor of the first hollow conductor bundle via the connecting member. This hollow conductor line ensures that the electromagnetic waves can be transferred from one point to another point.

According to an aspect, the connecting members are connected to the hollow conductors at their face sides. The hollow conductor system can be established easily since the separately formed parts are connected to each other at their dedicated ends, in particular the face sides of the hollow conductors. The face side corresponds to the front of the appropriate hollow conductor.

According to another aspect, the connecting member is inserted into the hollow conductors such that the hollow conductors surround the connecting member at least partly. A mechanically stable connection is provided since the connecting members are guided within the corresponding hollow conductors. Moreover, the total size is reduced as the area of the cross section of the connecting member is smaller than the one of the hollow conductors connected to the connecting member.

Furthermore, at least one hollow conductor may have an inclined face side with respect to its axial direction. The axial direction of the hollow conductor corresponds to the propagation direction of the electromagnetic waves transmitted via the hollow conductors. The inclined face side ensures that the connecting member is received by the hollow conductor in a certain manner providing different electromagnetic properties. For instance, the shielding properties are improved due to the inclined face side which in turn has a positive effect on the electrical losses. Additionally, the mechanical stability of the hollow conductor system is improved, in particular regarding bending stresses.

According to another aspect, a connection line is provided between each connecting member and the hollow conductor connected to the corresponding connecting member. The connection line ensures that the connecting member is fixedly connected with the hollow conductor bundle comprising the corresponding hollow conductor bundle. For instance, the connection line is a welding seam or a soldered seam. Alternatively, a detachable connection is provided wherein the connection line is provided by the transition line between the hollow conductor and the connecting member being inserted into the hollow conductor. The connection line is used for joining the connecting member and the hollow conductor.

In some embodiments, the connection line encloses the complete area of the cross section of the connecting member. As the connecting member is inserted, the connection line is provided at the outer surface of the connecting member. In other words, the connection line encircles the complete connecting member.

For instance, at least one connection line is inclined with respect to the cross section of at least one hollow conductor. As the face side of at least one hollow conductor is inclined, the corresponding connection line is also inclined with respect to the cross section of the dedicated hollow conductor. Thus, the connection line is inclined with respect to the axial direction which means that the connection line has an angle being different to 0° and 90°.

In some embodiments, the connection line is curved.

The connection line may run toward the void. The void is established between the connecting member and the adjacent connecting member as well as the adjacent hollow conductors. Thus, the face side of the hollow conductor is inclined such that more material of the hollow conductor is provided in the area adjoining the neighbored hollow conductor of the same hollow conductor bundle, in particular the outwardly positioned neighbored hollow conductor if the connecting member has a bent shape. This design has a positive effect on the electromagnetic properties, for instance the shielding properties. Hence, the electrical losses are minimized wherein the weight of the hollow conductor system is reduced, simultaneously.

According to another aspect, each hollow conductor bundle comprises at least three hollow conductors wherein at least three connecting members are provided such that at least two voids are provided between each neighbored connecting members. A multi beam hollow conductor system can be established easily with a small amount of parts as only two hollow conductor bundles are provided as well as the corresponding connecting members. Since the hollow conductor bundles each comprise several hollow conductors in a bundled manner, a very compact design is established wherein the manufacturing and assembling efforts are reduced with regard to the complexity of the hollow conductor system.

In some embodiments, the connecting member has a right-angled shape. The connecting member may be a muffle, in particular an H-plane bend or an E-plane bend.

Additionally, the void may have a substantially triangular shape. As the connecting members have a right-angled shape and the area of the cross section of the connecting members is reduced with respect to the one of the hollow conductors, the shape of the void is substantially triangular. Hence, a compact design is provided.

Each hollow conductor bundle may be formed by a main body made in one piece wherein the hollow conductors are formed by channels within the main body. This ensures the required mechanical stability as well as low manufacturing costs as the hollow conductor bundle can be manufactured in one process, for instance an extrusion process. Thus, the hollow conductor bundle may be extruded.

Embodiments of the disclosure further provide a method for manufacturing a hollow conductor system, for example, a hollow conductor system as described above, wherein at least two hollow conductor bundles are provided each having at least two hollow conductors separated by each other via a common intermediate wall, at least two connecting members are provided, the first connecting member is connected with one hollow conductor of each hollow conductor bundle, the second connecting member is connected with another hollow conductor of each hollow conductor bundle wherein a void is provided between the first connecting member and the adjacent second connecting member and/or an adjacent hollow conductor. In addition to the above mentioned advantages, the assembling is improved as only the hollow conductor bundles have to be connected with the connecting members. Thus, it is no more necessary to combine or connect the several individual hollow conductors with each other. Furthermore, the several hollow conductor lines can be established in a lightweight manner.

According to an aspect, each of the hollow conductors and the corresponding connecting members are connected with each other along a connection line. Thus, the connecting members have to be inserted into the hollow conductors of the different hollow conductor bundles. Afterwards, they are connected in the overlapping area such that a connection line is formed. Alternatively, a detachable connection is provided wherein the connection line is provided by the transition line between the hollow conductor and the connecting member being inserted into the hollow conductor.

According to another aspect, the connection line is established by a mechanical and/or chemical connection, for instance by welding, brazing, adhering, screwing and/or riveting. Thus, the connection line can be formed by a soldering, brazing and/or welding seam. Alternatively, an adhesive beam can be used. Furthermore, the connection line can be established by several screws and/or rivets defining a line which corresponds to the connection line. The assembling costs can be reduced due to the connecting techniques.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawing, wherein:

The FIGURE shows a hollow conductor system according to the disclosure.

### DETAILED DESCRIPTION

The detailed description set forth below in connection with the appended drawing, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the FIGURE, a hollow conductor system 10 is shown comprising two hollow conductor bundles 12, 14 and three connecting members 16, 18, 20.

The first hollow conductor bundle 12 comprises three different hollow conductors 22, 24, 26 and the second hollow conductor bundle 14 comprise three different hollow conductors 28, 30, 32. The three different hollow conductors 22, 24, 26 are separated from each other via intermediate walls 34, 36 and the three different hollow conductors 28, 30, 32 are separated from each other via intermediate walls 38, 40 such that an intermediate wall is provided between two adjacent hollow conductors of each hollow conductor bundle.

In general, the hollow conductor bundles 12, 14 each comprise a main body 42, 44 made in one piece such that the hollow conductors are formed by channels in the main bodies 42, 44. Accordingly, the intermediate walls 34-40 of the hollow conductor bundle 12, 14 are connected with each other by the walls defining the hollow conductors 22-32 inter alia. In other words, the hollow conductors 22-32 have pipe-like characteristics.

The hollow conductor bundles 12, 14 are formed such that the middle hollow conductor 24, 30 of each hollow conductor bundle 12, 14 is separated from the adjacent hollow conductors 22, 26 and 28, 32 of the same hollow conductor bundle 12, 14 by two intermediate walls 34, 36 and 38, 40, respectively.

For instance, the first intermediate wall 34 is provided between the first hollow conductor 22 and the second hollow conductor 24 of the first hollow conductor bundle 12 wherein the second hollow conductor 24 is also called middle hollow conductor. In addition, the second intermediate wall 36 is provided between the second hollow conductor 24 and the third hollow conductor 26 of the first hollow conductor bundle 12. The second hollow conductor bundle 14 is configured in the same or similar manner.

As shown in the FIGURE, each connecting member 16, 18, 20 connects one hollow conductor 22, 24, 26 of the first hollow conductor bundle 12 with the corresponding hollow conductor 28, 30, 32 of the second hollow conductor bundle 14 such that three different hollow conductor lines 46, 48, 50 are provided. The hollow conductor lines 46, 48, 50 are used for transferring electromagnetic waves propagating through the different hollow conductor lines 46, 48, 50 such that they can be transferred from one point to another point. For instance, electromagnetic waves are guided by the hollow conductor lines 46, 48, 50 from an antenna system to a certain device via the hollow conductor system 10.

The connecting members 16, 18, 20 and the hollow conductor bundles 12, 14, for example, their hollow conductors 22, 24, 26, 28, 30, 32, are formed such that two voids 52, 54 occur in the connection area of the connecting members 16, 18, 20 and the hollow conductor bundles 12, 14.

The first void 52 is limited by the first connecting member 16, the second hollow conductor 24 of the first hollow conductor bundle 12, the second hollow conductor 30 of the second hollow conductor bundle 14 as well as the second connecting member 18 which connects the second hollow conductors 24, 30 of both hollow conductor bundles 12, 14.

The second void 54 is limited by the second connecting member 18, the third hollow conductor 26 of the first hollow conductor bundle 12, the third hollow conductor 32 of the second hollow conductor bundle 14 as well as the third connecting member 20. The third connecting member 20 connects the third hollow conductors 26, 32 of both hollow conductor bundles 12, 14.

Generally, the voids 52, 54 are provided each between one connecting member 16 , 18, 20 and the adjacent connecting member 16, 18, 20 and/or hollow conductors 22, 24, 26, 28, 30, 32 being adjacent to those which are connected by the dedicated connecting member 16, 18, 20.

As shown in the FIGURE, the voids 52, 54 have a triangular shape due to the design of the connecting members 16, 18, 20 and the hollow conductor bundles 12, 14, in particular their hollow conductors 22, 24, 26, 28, 30, 32.

The voids 52, 54 ensure that different materials adjoin each other which have different dielectric properties, in particular air and the material of the hollow conductor bundles 12, 14. Thus, the electrical losses can be reduced when electromagnetic waves propagate through the hollow conductor lines 46, 48, 50.

Each of the connecting members 16, 18, 20 is connected with the corresponding hollow conductors 22-32 such that a connection line 56, 58, 60, 62, 64, 66 is provided.

As shown in the FIGURE, the connection lines 56, 58, 62, 64 provided between the first connecting member 16 and the corresponding first hollow conductors 22, 28 and the second connecting member 18 and the corresponding second hollow conductors 24, 30 distinguish from the connection lines 60, 66 provided between the third connecting member 20 and the corresponding third hollow conductors 26, 32.

The third connection lines 60, 66 are ring-shaped since the corresponding third hollow conductors 26, 32 have a face side being parallel to the cross section of the third hollow conductors 26, 32. Thus, the face sides of the third hollow conductors 26, 32 are perpendicular with respect to the axial direction of the third hollow conductors 26, 32.

In contrast thereto, the other connection lines 56, 58, 62, 64 of the first and second hollow conductor lines 46, 48 are inclined with respect to the cross section of the first and second hollow conductors 22, 24, 28, 30 since the face sides of the first and second hollow conductors 22, 24, 28, 30 of both hollow conductor bundles 12, 14 are inclined with respect to their axial direction.

In general, the hollow conductors 22, 24, 26, 28, 30, 32 of their respective hollow conductor bundles 12, 14 have the same axial direction which corresponds to the propagation direction of the electromagnetic waves within the dedicated hollow conductor bundles 12, 14, in particular their hollow conductors 22, 24, 26, 28, 30, 32. As shown in the FIGURE, the connection lines 56, 58, 62, 64 between the first and second connecting members 16, 18 and the corresponding hollow conductors 22, 24, 28, 30 run toward the corresponding voids 52, 54. Thus, the inserted connecting members 16, 18 are encircled in an asymmetrical manner by the corresponding hollow conductors 22, 24, 28, 30 due to their inclined face sides. Accordingly, the sides merging into the voids 52, 54 are shielded by more material with respect to the opposing sides.

This configuration improves the mechanical stability, in particular with regard to bending stresses, as well as the electromagnetic properties such that the electrical losses are minimized.

As can be seen, the connection lines 56, 58, 62, 64 are curved as one half of each connection line 56, 58, 62, 64 is formed as a half circle or a half ring whereas the other half of each connection line 56, 58, 62, 64 runs toward the corresponding void 52, 54. For instance, the connection lines 56, 58, 62, 64 run toward the corresponding void 52, 54 by a distance being equal to the radius of the corresponding hollow conductor 22, 24, 28, 30. Generally, the inclined and curved connection lines 56, 58, 62, 64 are established due to these configurations.

In addition, the intermediate walls 34, 36, 38, 40 protrude into the corresponding void 52, 54 at least partly. Particularly, the intermediate walls 34, 36, 38, 40 adjoining the part of the connection line 56, 58, 62, 64 which run toward the corresponding void 52, 54 protrude the dedicated parts of the connection lines 56, 58, 62, 64. Thus, the voids 52, 54 are limited by the connecting members 16, 18, 20 as well as the portions of the intermediate walls 34, 36, 38, 40 which protrude the parts of the connection lines 56, 58, 62, 64 running toward the corresponding voids 52, 54.

As the connecting members 16, 18 have a substantially right-angled shape, the sides of the connecting members 16, 18 facing to the outside surrounded by more material due to the inclined connection lines 50, 52, 54, 56, in particular the inclined face sides of the corresponding hollow conductors 22, 24, 28, 30.

In some embodiments, the hollow conductors 22, 24, 26, 28, 30, 32 may have a circular cross section being larger than the one of the connecting members 16, 18, 20 which can be inserted into the face sides of the hollow conductors 22, 24, 26, 28, 30, 32.

As the hollow conductors 22, 24, 26, 28, 30, 32 are separated from each other by the intermediate walls 34, 36, 40, the hollow conductor bundles 12, 14 have a shape being similar to a cigar bundle wherein each hollow conductor 22, 24, 26, 28, 30, 32 corresponds to a cigar due to their round shape.

The hollow conductor system 10 shown in the FIGURE is assembled by providing the hollow conductor bundles 12, 14 as well as the connecting members 16, 18, 20. The connecting members 16, 18, 20 are inserted into the first, second and third hollow conductors 22, 24, 26, 28, 30, 32 of each hollow conductor bundle 12, 14, in particular at their face sides, such that the hollow conductors 22, 24, 26, 28, 30, 32 encircles the connecting members 16-20. Then, the hollow conductor lines 46, 48, 50 are established.

Due to the shape of the hollow conductor bundles 12, 14 as well as the connecting members 16, 18, 20, two voids 52, 54 are provided between connecting members 16, 18, 20 being adjacent to each other. For instance, the voids 52, 54 are limited by one connecting member 16, 18, the neighbored connecting member 18, 20 as well as the hollow conductors 24, 26, 30, 32 being adjacent to the hollow conductors 22, 24, 28, 30 which are connected to the one connecting member 16, 18.

Afterwards, the connecting members 16, 18, 20 and the hollow conductor bundles 12, 14 are connected with each other, in particular their hollow conductors 22, 24, 26, 28, 30, 32, wherein they can be welded, soldered, brazed, adhered, screwed and/or riveted with each other.

Since at least the face sides of the first and second hollow conductors 22, 24, 28, 30 have an inclined face side with respect to the axial direction of the hollow conductor bundles 12, 14 or their cross sections, inclined connection lines 56, 58, 62, 64 are provided. The connection lines 56, 58, 62, 64 run toward the voids 52, 54.

In some embodiments, each hollow conductor bundle 12, 14 may comprise two or more hollow conductors. In some embodiments, each hollow conductor bundle 12, 14 may comprise three or more hollow conductors. In general, each hollow conductor bundle 12, 14 may comprise two or more than three hollow conductors.

Accordingly, a multi beam hollow conductor system 10 can be established wherein the electrical losses are minimized. In addition, the mechanical properties are improved such as weight reduction and increased mechanical stability. Furthermore, the manufacturing and assembling efforts are reduced which in turn reduces the costs of the whole hollow conductor system 10.

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. The term “about,” “approximately,” “substantially,” “near” etc., means plus or minus 10% of the stated value or condition.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A hollow conductor system comprising at least two hollow conductor bundles and at least two connecting members wherein each hollow conductor bundle comprises at least two hollow conductors separated by each other via a common intermediate wall, each connecting member connecting one hollow conductor of one hollow conductor bundle with a corresponding hollow conductor of the other hollow conductor bundle such that a void is provided between the connecting member and the adjacent connecting member and/or an adjacent hollow conductor.

2. The hollow conductor system according to claim 1, wherein the connecting members are connected to the hollow conductors at their face sides.

3. The hollow conductor system according to claim 1, wherein the connecting members are inserted into the hollow conductors such that the hollow conductors surround the corresponding connecting members at least partly.

4. The hollow conductor system according to claim 1, wherein at least one hollow conductor has an inclined face side with respect to its axial direction.

5. The hollow conductor system according to claim 1, wherein a connection line is provided between each connecting member and the hollow conductor connected to the corresponding connecting member.

6. The hollow conductor system according to claim 5, wherein the connection line encloses the complete area of the cross section of the connecting member.

7. The hollow conductor system according to claim 5, wherein at least one connection line is inclined with respect to the cross section of at least one hollow conductor.

8. The hollow conductor system according to claim 5, wherein at least one connection line runs toward the void.

9. The hollow conductor system according to claim 1, wherein the void has a substantially triangular shape.

10. The hollow conductor system according to claim 1, wherein each hollow conductor bundle comprises at least three hollow conductors, at least three connecting members being provided such that at least two voids are provided between each neighbored connecting members.

11. The hollow conductor system according to claim 1, wherein the connecting member has a right-angled shape.

12. The hollow conductor system according to claim 1, wherein each hollow conductor bundle is formed by a main body made in one piece, the hollow conductors being formed by channels within the main bodies.

13. A method for assembling a hollow conductor system comprising the following steps:
providing at least two hollow conductor bundles each having at least two hollow conductors separated by each other via a common intermediate wall;
providing at least two connecting members;
connecting the first connecting member with a first hollow conductor of each hollow conductor bundle; and
connecting the second connecting member with a second hollow conductor of each hollow conductor bundle, wherein
a void is provided between the first connecting member and the adjacent second connecting member and/or an adjacent hollow conductor.

14. The method according to claim 13, wherein each of the hollow conductors and the corresponding connecting members are connected with each other along a connection line.

15. The method according to claim 13, wherein the connection line is established by a mechanical and/or chemical connection.

16. The method according to claim 13, wherein the hollow conductor system comprises the at least two hollow conductor bundles and the at least two connecting members, and wherein each of the hollow conductor bundles comprise at least two hollow conductors separated by each other via a common intermediate wall, each connecting member connecting one hollow conductor of one hollow conductor bundle with a corresponding hollow conductor of the other hollow conductor bundle.

17. The method according to claim 13, wherein the mechanical or chemical connection includes one of welding, brazing, soldering, adhering, screwing, or riveting.
